(19) United States
(12) Patent Application Publication
(10) Pub. No.: US 2013/0291629 A1
(43) Pub. Date: Nov. 7, 2013

(54) ENGINE WEAR DETECTION SYSTEM

(71) Applicant: Michael Falzarano, Glen Cove, NY (US)

(72) Inventor: Michael Falzarano, Glen Cove, NY (US)

(73) Assignee: Michael Falzarano and Associates, Inc., Glen Cove, NY (US)

(21) Appl. No.: 13/464,439

(22) Filed: May 4, 2012

(51) Int. Cl. G01M 15/00

(52) U.S. Cl. 73/114.01; 73/865.8

(57) ABSTRACT

An engine wear detection system includes (a) detector for generating a signal correlated with the rotation of a rotary member of an engine; (b) a processor for processing said signal to determine the number of rotations performed by the rotary member; and, (c) a cyclometer display for visually displaying the cumulative number of rotations.

### BACKGROUND

1. Field of the Invention

This invention relates to the art of engine instrumentation and more particularly to a system for measuring engine wear.

2. Background of the Art

Engine diagnostic devices are known in the art. For example, U.S. Pat. No. 2,159,236 to Uher discloses a device for continuously registering the revolutions of an internal combustion engine in consideration of the actual load. The Uher device indicates the total load taken up by a combustion engine but does not provide a digital display of the number of revolutions.

U.S. Pat. No. 3,379,056 to Ellison discloses an engine wear meter responsive to the pressure in the intake manifold of an internal combustion engine. The engine wear meter includes a counter responsive to an output signal representative of the pressure in the intake manifold.

U.S. Pat. No. 3,463,384 to Kilbane discloses a system for sensing the wear of the vanes of a rotary compressor. The system is designed to obviate the need for disassembling a sliding vane rotary compressor to determine if the vanes need to be replaced.

U.S. Pat. No. 3,948,039 to Leveraus discloses an electrical circuit for operating an hour meter on a tractor for registering the operating time of the engine.

U.S. Pat. No. 4,065,961 to Crew discloses an engine diagnostic system for monitoring fuel consumption. The system monitors manifold pressure and includes a counter for counting over-accelerations and the number of vacuum drops associated with engine stops.

U.S. Pat. No. 4,129,037 to Toalson discloses a method and apparatus for measurement of expected wear of mechanisms subjected to wear inducing factors such as time, speed, pressure, temperature, etc.

The above listed patents are herein incorporated by reference.

What is yet needed is a simple method for monitoring engine wear in an internal combustion engine or electrical engine. Learning the true wear on an engine is especially important before, for example, purchasing a used automobile. It is not sufficient to know only how many miles an automobile has traveled. For example, an automobile carrying a heavy load or traveling uphill will require more engine revolutions to supply additional power. This will cause the transmission to downshift to a lower gear and increase the rotations per minute (RPM). Accordingly, the engine will experience more wear over a particular travel distance than a similar automobile traveling the same distance but without carrying such a load. Also, over-acceleration followed by frequent braking, or long periods of idling, will also cause engine wear which is not reflected in an odometer reading. Yet such conditions are common features of city driving with stop-and-go traffic. Accordingly, the present invention is provided to address this need for a more accurate method of determining engine wear.

### SUMMARY

Provided herein is an engine wear detection system which comprises (a) detector configured for generating a signal correlated with the rotation of a rotary member of an engine; (b) processor configured to receive and process said signal to determine the number of rotations performed by the rotary member; and, (c) cyclometer display configured for visually displaying the cumulative number of rotations. An instrument panel of a motor vehicle can include a tachometer for visually displaying the engine speed and a cyclometer for displaying the cumulative number of rotations of a rotary member of the engine.

Also provided is an instrument panel of a motor vehicle having an engine, the instrument panel including a cyclometer for visually displaying the cumulative number of rotations of a rotary member of the engine.

In another embodiment the instrument panel of the motor vehicle can include both the cyclometer of the invention and a tachometer for measuring engine rotation speed.

Also provided herein is a method for determining the wear of an engine comprising: (a) measuring the number of rotations of a rotary member of the engine; and (b) visually displaying the cumulative number of rotations of the rotary member.

### BRIEF DESCRIPTION OF THE DRAWINGS

Various embodiments are described below with reference to the drawings wherein:

FIG. 1 is a schematic view of an engine wear detection system of the invention;

FIG. 2 is a schematic view of an electro-optic sensor used in conjunction with a laser;

FIG. 3 illustrates a tachometer-cyclometer display employing the wear detection system in conjunction with other instrumentation on the dashboard of an automobile;

FIG. 4. is a schematic illustration of the electrical connection of the cyclometer device of the invention with the ignition system of a motor vehicle; and,

FIG. 5 illustrates an engine instrumentation panel with the cyclometer of the invention.

### DETAILED DESCRIPTION OF PREFERRED EMBODIMENT(S)

The present invention includes a cyclometric system associated with an engine for measuring the cumulative number of rotations of a rotary member of the engine (e.g., crankshaft, cam shaft, flywheel, etc.) and visually displaying the number in a cyclometer display. In an embodiment, the visual display of the number of rotations is in conjunction with a display of the rotation speed of the rotary member, for example, a combined cyclometer-tachometer display.

In another embodiment the invention includes a stand-alone cyclometer display in conjunction with the instrument panel, or dashboard, of a motor vehicle.

The present disclosure may be understood more readily by reference to the following detailed description of the disclosure taken in connection with the accompanying drawing figures, which form a part of this disclosure. It is to be understood that this disclosure is not limited to the specific devices, methods, conditions or parameters described and/or shown herein, and that the terminology used herein is for the purpose of describing particular embodiments by way of example only and is not intended to be limiting of the claimed disclosure. Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure. For example, the references “upper” and “lower” are relative and used only in the context to the other, and are not necessarily “superior” and “inferior”.

The following discussion includes a description of a system, mechanism and related methods of employing the system and mechanism in accordance with the principles of the present disclosure. Alternate embodiments are also disclosed. Reference will now be made in detail to the exemplary embodiments of the present disclosure, which are illustrated in the accompanying figures.

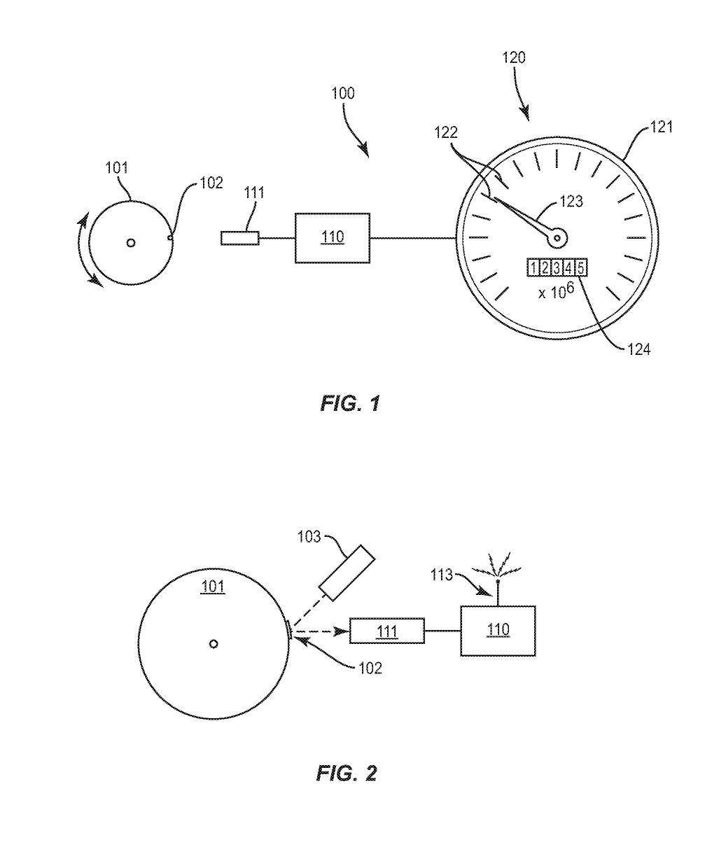

Referring to FIG. 1, in an embodiment of the invention an engine includes a rotary member, i.e., crankshaft 101. In an embodiment, the system of the present invention includes a sensor 111 positioned in proximity to the crankshaft 101, and detects the rotation of the crankshaft. Various methods can be used by the sensor 111 to determine a rotation. For example, the marking 102 can be magnetic and electromagnetically detected by sensor 111. A sensor suitable for use in the present invention is a Hall effect sensor that varies its output voltage in response to a magnetic field. The Hall effect sensor typically operates as an analog transducer, but can be combined with circuitry to operate in a digital mode. Such transducers can be used in automotive internal combustion engines for ignition timing and tachometers. In the present invention the Hall effect sensor is used in conjunction with counting circuitry in a processing unit 110. Alternatively, the crankshaft 101 can include a marking 102 which can be optically detected by a photoelectric sensor, optionally in conjunction with a laser. Referring to FIG. 2, sensor 111 can be an electro-optic sensor that includes a photodiode to convert light rays to an electronic signal. Used in conjunction with a laser 103, marking 102 can be a highly reflective surface, which, distinguished in reflectivity from the remaining surface of the rotating shaft 101, reflects a light beam from laser 103 back to the electro-optic sensor 111. The signal generated by the sensor 111 is then sent to the processing unit 110 for counting. Electro-optic sensors and Hall effect sensors are known in the art and commercially available. Various other ways of detecting rotation of a shaft in an engine are known in the art and can be employed in the present invention. For example, other rotating members can be used, alternatively or in addition to, the crankshaft as indicators of engine wear such as camshafts and flywheels, and the wear detection system of the invention can alternatively be used to determine the rotation of these other members. As mentioned above, the sensor 111 generates an electric signal that is transmitted to the processing unit 110. The processing unit 110 counts the number of rotations indicated by the signals from the sensor, and further sends information to a cyclometer display, i.e., cyclometer display 124, shown as a digital counter, which displays the number of rotations. Additionally, the processing unit 110 can include a clock mechanism so as to determine the cumulative number of rotations within a predetermined period of time, i.e., the rotation speed of the rotary drive. The information of the rotation speed is typically formatted as rotations per minute (RPM), which is then sent to a tachometer 120 for visual display. The transmission of signals from the sensor and/or from the processing unit can be done by means of wire connections. Alternatively, as illustrated in FIG. 2, the processing unit 110 (and/or senor 111) can transmit the signals wirelessly via an antenna 113 to a receiver, for example, in the cyclometer display.

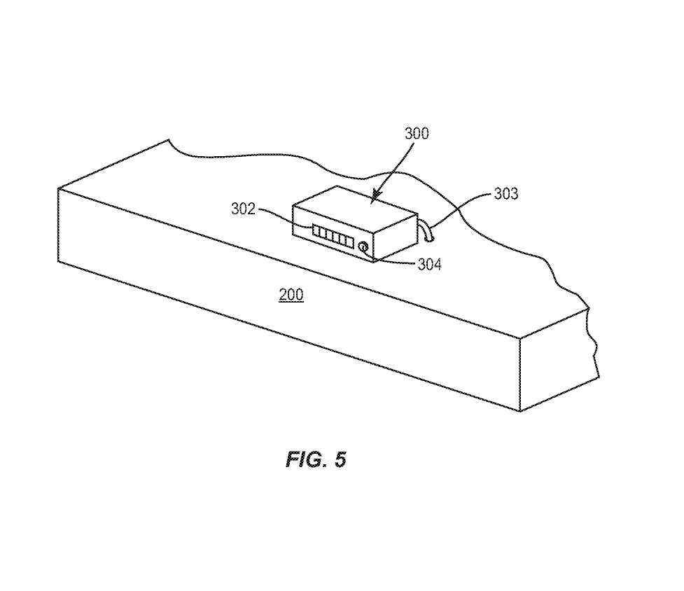

In an embodiment as illustrated in FIG. 4 and discussed more fully below, the system of the invention can determine the rotations of the engine by counting the number of pulsations of the current or voltage in the ignition system, the number of pulsations being associated with the number of shaft rotations. Many motor vehicles currently provide access to terminals for electrical connection to the ignition system. As with conventional tachometers, the system of the invention can use this convenient method to count rotations.

In an embodiment, as an anti-fraud feature the processing unit 110 can include encrypted storage of the cyclometric data that cannot be reset without a password or decryption key held only by the manufacturer. Also, in the event that transmission of data is sent wirelessly, the data can be encrypted.

A typical analog tachometer in an automobile comprises a circular dial having RPM indicia arranged circumferentially in the vicinity of the circumferential border of the dial. A rotary pointer 123 rotates to indicate the engine speed in RPM. In an embodiment of the present invention, the cyclometer display 124 is associated with the tachometer and preferably digitally displays the cumulative number of rotations performed by the engine. Alternatively, the cyclometer display can be a mechanical analog display comprising, for example, a circular dial and rotatably mounted pointer for indicating the cumulative number of shaft rotations. In an embodiment, the tachometer can also comprise a digital display of the rotation speed. Moreover, the digital displays of the tachometer 120 and/or cyclometer display 124 can be mechanical or electronic visual displays.

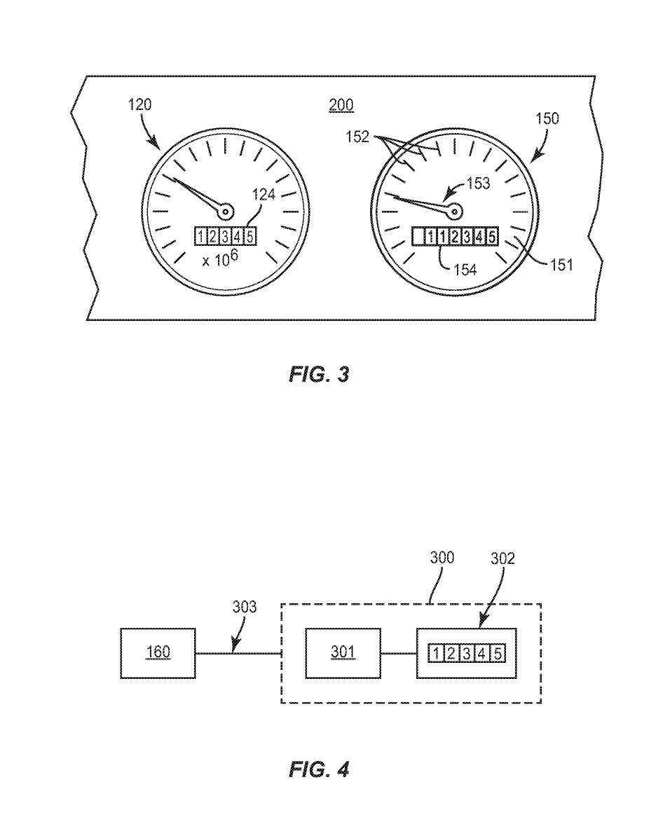

Referring now to FIG. 3, in a preferred embodiment, a tachometer in combination with the cyclometer display 124 are mounted to the dashboard 200 of a motor vehicle in conjunction with a speedometer 150 and odometer 154. The speedometer typically comprises a dial 151 with travel speed indicia 152 (e.g., in miles/hr or kilometers/hr) and a pointer 153. Digital speed displays can alternatively be employed. The odometer 154 registers the travel distance of the vehicle (in miles or kilometers).

Referring now to FIG. 4, in an embodiment the system of the invention includes a cyclometer device 300, which includes an internal processor 301 operatively connected to a cyclometer display 302. The cyclometer device 300 is electrically connected via a wire or cable 303 to the ignition system 160 of the motor vehicle. As discussed above, it is possible to determine the number of rotations of the rotary member in an internal combustion engine by detecting the electrical pulsations from, for example, the ignition coil. The number of pulsations corresponds to the number of rotations. Various ways of making the appropriate electrical contacts can be employed depending on the engine design and are known to those skilled in the art.

Referring to FIG. 5, the cyclometer device 300 is shown mounted to the dashboard 200 of a motor vehicle. In an embodiment, the cyclometer device 300 can be an aftermarket product, which can be retrofit into an already purchased motor vehicle. In an embodiment, the processor 301 can monitor the cumulative number of engine rotations for establishing a maintenance schedule. In an embodiment, the cyclometer device 300 can include a visual indicator 304 to indicate whether maintenance is due after a predetermined number of rotations has been reached. For example, the indicator 304 can flash a light colored to correspond to the necessity for maintenance.

Usually, when purchasing a used vehicle, the prospective buyer checks the odometer to determine how far the vehicle has traveled as a measure of wear. Odometer readings play a significant role in determining the price of a vehicle. However, as stated previously, vehicle rarely provides an accurate indicator of the wear on an engine. Vehicles hauling heavy loads such as trailers will require higher engine speeds and more RPM to travel the same distance as a vehicle without such a load. Since engine wear is most strongly related to the number of engine rotations, odometer readings by themselves are an indirect and rarely accurate indication of engine wear. The combination of engine rotation readings with odometer readings provides a much better indication of the condition of the motor vehicle.

Although the system of the invention is advantageously used in conjunction with such motor vehicles as automobiles, trucks, motorcycles, snowmobiles, and tractors and other farm equipment, use is not limited to such land vehicles. For example, the system of the invention can advantageously be used in conjunction with outboard or inboard marine engines for watercraft, as well as trains or aircraft engines, which do not have odometers. Moreover, the present invention is not limited to internal combustion engines but may also be advantageously used in conjunction with electric powered vehicles or any equipment having rotary or reciprocating parts such as household appliances (e.g., washing machines and dryers), lawn mowers, drills, jackhammers, pumps, fans, power saws, lathes, generators, propellers, turbines, etc.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. An engine wear detection system comprising:
a) detector configured for generating a signal correlated with the rotation of a rotary member of an engine;
b) processor configured to receive and process said signal to determine the number of rotations performed by the rotary member; and,
c) cyclometer display configured for visually displaying the cumulative number of rotations.

2. The system of claim 1 wherein the detector comprises an optical sensor positioned in the vicinity of the rotary member.

3. The system of claim 1 wherein the detector comprises an electromagnetic sensor positioned in the vicinity of the rotary member.

4. The system of claim 1 wherein the rotary member comprises a crankshaft, cam shaft or flywheel.

5. The system of claim 1 wherein the cyclometer display comprises a digital counter.

6. The system of claim 1 further including a timer, wherein the processor further determines the rotation speed of the crankshaft, and the system further includes a tachometer, which visually displays the rotation speed.

7. An engine in combination with the engine wear detection system of claim 1.

8. An instrument panel of a motor vehicle having an engine, the instrument panel including a tachometer configured for visually displaying the engine speed and a cyclometer display configured for visually displaying the cumulative number of rotations of a rotary member of the engine.

9. The instrument panel of claim 8 wherein the engine is an internal combustion engine.

10. The instrument panel of claim 8 wherein the tachometer is an analog tachometer.

11. The instrument panel of claim 8 wherein both the tachometer and cyclometer display comprise digital displays.

12. The instrument panel of claim 11 wherein the cyclometer display comprises a mechanical display.

13. The instrument panel of claim 11 wherein both the tachometer and cyclometer display comprise electronic displays.

14. The instrument panel of claim 11 wherein the rotary member comprises a crankshaft, cam shaft or flywheel.

15. A method for determining the wear of a motor comprising:
a) counting the number of rotations of a rotary member of the motor; and,
b) visually displaying the cumulative number of rotations of the rotary member.

16. The method of claim 15 wherein said motor is an engine in a motor vehicle, and the motor vehicle includes a cyclometer display for displaying the number of rotations, wherein the step of visually displaying the number of rotations comprises mounting said cyclometer display to a dashboard of the motor vehicle.

17. The method of claim 16 wherein the motor is an internal combustion engine.

18. The method of claim 17 wherein the rotary member is a crankshaft, cam shaft or flywheel.

19. The method of claim 16 wherein the motor is an electric engine.

20. The method of claim 15 wherein the motor is for equipment selected from the group consisting of trucks, motorcycles, snowmobiles, tractors or other farm equipment, outboard or inboard marine engines, trains, aircraft, household appliances, lawn mowers, drills, jackhammers, pumps, fans, power saws, lathes, generators, propellers and turbines.
